(19) United States
(12) Patent Application Publication
(10) Pub. No.: US 2019/0144315 A1
(43) Pub. Date: May 16, 2019

(54) REMEDIATION AND RECYCLING OF FRAC WATER AND FLOW BACK WATER

(71) Applicant: RecyClean Services LLC, Houston, TX (US)

(72) Inventor: Mark E. Stanley, Spring, TX (US)

(73) Assignee: RecyClean Services LLC, Houston, TX (US)

(21) Appl. No.: 16/242,906

(22) Filed: Jan. 8, 2019

Related U.S. Application Data
(63) Continuation of application No. 14/180,521, filed on Feb. 14, 2014.

(51) Int. Cl. C02F 1/78; C02F 1/463

(52) U.S. Cl. CPC C02F 1/78; C02F 2101/32; C02F 2201/4613; C02F 1/463

(57) ABSTRACT

A method and device for treating contaminated water where the device is portable. The method includes the steps of moving contaminated water into a first tank to settle out large solids such as cuttings and metallic particles while adding a pH modifier, a coagulant, and gaseous ozone. Moving the contaminated water into a second tank where the pre-treated water is subjected to an electro-coalescing process that subjects the water to a strong DC current as the water passes between several bi-metallic plates. After the electro-coalescing process the water may be filtered to remove the remaining solids resulting from the pre-treatment and the electro-coalescing process or the solids may be allowed to settle. The resulting water may then be re-used in the fracturing or drilling processes.

### CROSS-REFERENCE TO RELATED APPLICATIONS

This application claims priority to U.S. patent application Ser. No. 14/180,521 that was filed on Feb. 14, 2014.

### FIELD OF INVENTION

This invention relates to the field of water treatment and, in particular to provide water for fracturing and drilling, as well as reducing the need for off-site treatment. Such treatment may include reclaiming the water from drilling fluids, flowback fluids, and produced water from oil and gas weds.

### BACKGROUND

The oil and gas industry has a requirement for water that is needed for oil and gas drilling and fracturing. Typically it is useful to add particular chemicals to enhance the function of the water for both drilling and fracturing operations. Unfortunately these chemicals may be sensitive to salts or other chemicals that may be present in the water. One potential source of water near a drilling site is flowback water and produced water from other nearby wells. However, flowback and produced water is typically highly contaminated with various salts, acids, hydrocarbons, solids, and other contaminants. There is a need in the oil and gas industry to have a relatively uncontaminated water source to use in drilling and fracturing procedures. Additionally, once the drilling and fracturing procedures are over there is a need to remove the various contaminants from the drilling and fracturing fluids in order to properly dispose of the fluids. There may also be water that is produced from the well along with the various desired hydrocarbons, such water is preferably separated out from the hydrocarbons at the well site and must then be able to be disposed of properly.

### SUMMARY

One solution is outlined as follows. The initial step is the introduction of the contaminated water into a tank, such as a 10,000 gallon overflow tank. This first tank is usually the first step in the treatment process as it enables solids such as rock cuttings, metals, or other solids produced in oil and gas operations to settle out of the water while ozone is diffused into the water. Additionally the pH of the water may also be adjusted at this stage, usually by the addition of NaOH to adjust the pH to about 9.2. As the water is moved from this initial tank it is pumped through a tank or tanks where the water is subjected to an electro-coalescing process.

The electro-coalescing process typically consists of moving the contaminated water out of the first tank and into a second tank where the water passes through bimetallic electrodes. A direct current power supply, supplies a DC electric current to electrodes. The power passing through the water between the at least two bi-metallic electrodes tends to enhance the formation of additional solids to be extracted from the water being treated. As the contaminated water, that has both organic and nonorganic pollutants, is pumped through a series of coalescing cells or between the electrodes in a single tank, the DC the current creates a charge in the pollutants. The now electrically charged pollutants tend to coalesce into large enough particles so that the pollutant particles will either settle in the overflow tank or may be filtered out.

After passing through the pre-treatment in the first tank or cell as well as passing through the electro-coalescing process, the contaminated water in the overflow tank typically shows signs of clarity but continues to have a level of turbidity due to the complex chemistry of the flow back water and continues to have high levels of pollutants such as various chemical agents, petroleum hydrocarbons, and volatile organic compounds that tend to be too stable for the electro-coalescing process to completely eradicate them. The water may have to be treated by injecting an additional coagulant into the flow to coalesce the final pollutants into solids that are then removed thereby rendering the water suitable for reuse in the fracturing and drilling processes or for other environmentally friendly disposal. The coagulant or flocculant may be a polymer.

One embodiment of the invention includes injecting ozone into the contaminated water and adjusting the pH of the water in the first tank. Typically the pH of the water is modified by injecting NaOH into the water, usually to at least 9.2 pH. Then flowing the water between at least two electrodes where an electric current is supplied to the electrodes. Typically the electrodes are metal and in some instances the metal electrodes are bimetallic. Usually the electric current is direct current (DC). Typically, the current supplied to the electrodes is reversed at after a period of time. Injecting a polymer into the water and allowing a coagulated material to settle out of the water.

In another embodiment of the invention the fluid treatment system has a skid with a first tank and an ozone source. Usually the contaminated water is introduced into the first tank along with ozone from the ozone source. Then a multiplicity of first solid particles are allowed to settle out in the first tank. The fluid treatment system skid may have a second tank and an electric power supply, wherein power supply is connected to electrodes in the second tank. The electric power supply is usually DC and the electrodes are bimetallic. The contaminated water from the first tank passes between the electrodes in the second tank. A polymeric coagulant may be added after the water passes through the electrodes. Typically the skid has a pH modifying agent and the modifying agent is introduced into the first tank. In most instances the pH modifying agent is NaOH.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic flow chart of the water treatment process.

FIG. 2 depicts a schematic layout of a fluid treatment system control system and electrocoalescing tanks on a first skid.

FIG. 3 depicts a schematic layout of a fluid treatment system ozone injection tank and a coagulation tank on a second skid.

FIG. 4 depicts a schematic layout of a fluid treatment system on a single skid.

### DETAILED DESCRIPTION

The description that follows includes exemplary apparatus, methods, techniques, and instruction sequences that embody techniques of the inventive subject matter.

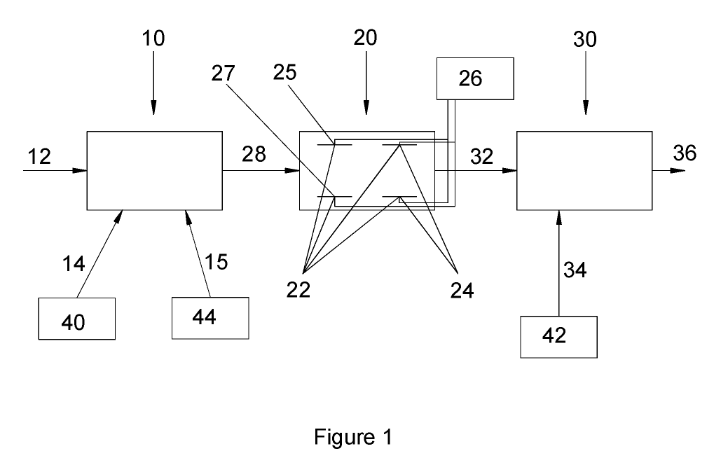

The methodology employs electrical energy, ozone, and chemical modification to alter the molecular structure of waterborne contaminants to remove those contaminants. FIG. 1 depicts a flow chart outlining a process for treating drilling or fracturing fluids as well as produced, flowback, or otherwise contaminated water. A representative fluid management system uses a high flow design to process and recycle fracturing, flowback, or other wastewater.

The typical water processing cycle is a continuous process although a quantitative or timed process may be used. Typically, contaminated water enters the first tank 10 as indicated by arrow 12. While the contaminated water is in the first tank 10 at least a portion of the solids may be allowed to settle. Also, the first tank 10 may provide a large enough basin for the pretreatment of the contaminated water to begin. The pre-treatment process may include injecting gaseous ozone from the ozone tank 40 into the contaminated water in the first tank 10, as indicated by arrow 14.

It is been found that typically produced water is slightly acidic, usually with a pH between 5.0 and 6.5. However the treatment process has been found to be most successful with the pH above about 9.1. In order to modify the pH, a base such as sodium hydroxide (NaOH), may be metered from a tank 44 containing the base into the contaminated water in the first tank 10, as indicated by arrow 15, as the contaminated water makes its way through the first tank 10.

Once the water has been pre-treated and many of the solids have been settled out in the first tank, the contaminated water is moved into a second tank 20, as indicated by arrow 28 where the treating process moves into the next phase. In the second tank 20 the contaminated water moves through at least one, but typically a series of ten electrode assemblies 22, two such electrode assemblies 22 are shown, where the water and contaminants are subjected to electro-coalescing. Typically each electrode assembly 22 has a number of paired sacrificial metallic electrodes 24, typically the electrodes are bimetallic and are iron and aluminum. The electrodes 24 are energized by source of DC power 26. Typically the DC power source 26 supplies three phase 220 volt power between 200 and 400 amps.

As DC current is supplied to each pair of electrodes 24 positive DC power is applied to one electrode 25 while negative DC power is applied to the other electrode 27. Every so often the polarity of the electrodes 24 is reversed so that previously positively charged electrode 25 becomes negatively charged while previously negatively charged electrode 27 becomes positive. Each electrode 25 and 27 does not retain a positive or negative charge long enough to impact the collection of sediment near each electrode 25 or 27. Typically by reversing the polarity the pairs of electrodes 25 and 27 are only subject to degradation by ion displacement.

As a result of the pretreatment in the first tank 10, including ozone injection and pH adjustment and the electro-coalescing treatment in the second tank 20 the contaminated water typically begins to clarify. However usually microscopic suspended solids, stable sulfates, surfactants, emulsifying agents, petroleum hydrocarbons, and volatile organic compounds are still present in the water. Therefore in certain instances a chemical coagulation process is called for.

Typically the water is then moved into a third tank 30, as indicated by arrow 32, where a low molecular weight, high charge cationic polymer, such as any of the polyacrylam ides including polyethylene-imines, polyamides-amines, or polyamines, is added to the water from the tank 42 into the water in the third tank 30, as indicated by arrow 34, causes additional gathering and coagulation of the remaining suspended colloids, including the stable sulfates, surfactants, emulsifying agents, petroleum hydrocarbons, and volatile organic compounds into large clusters of solids that may range from 20-100 microns in size. Usually the low molecular weight, high charge cationic polymer is a solution of polyaluminum chloride and dodecylmethylallylchloride is used to cause the additional gathering and coagulation of the remaining suspended colloids. These coalesced solids are then capable of being settled or filtered out of the water for off-site removal. After the solids are extracted and removed the water is now ready to return to the oil exploration well site, as indicated by arrow 36, where it may be removed from the site for proper local disposal or the water may be re-used in either a drilling or fracturing process.

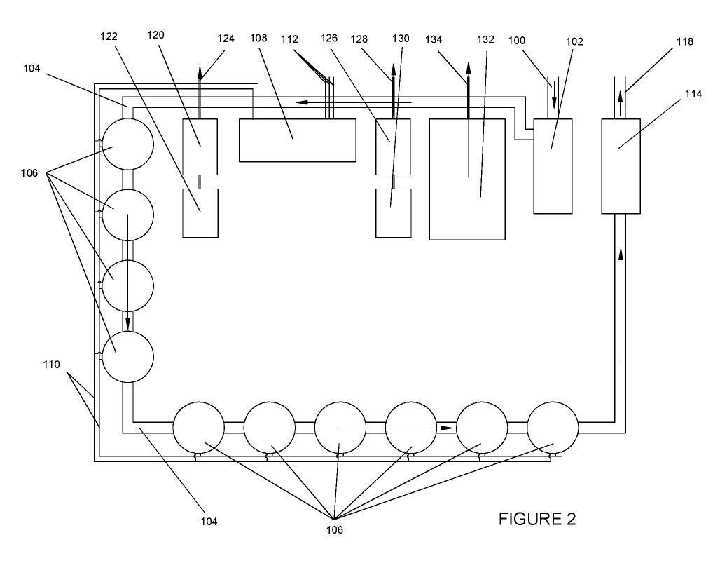

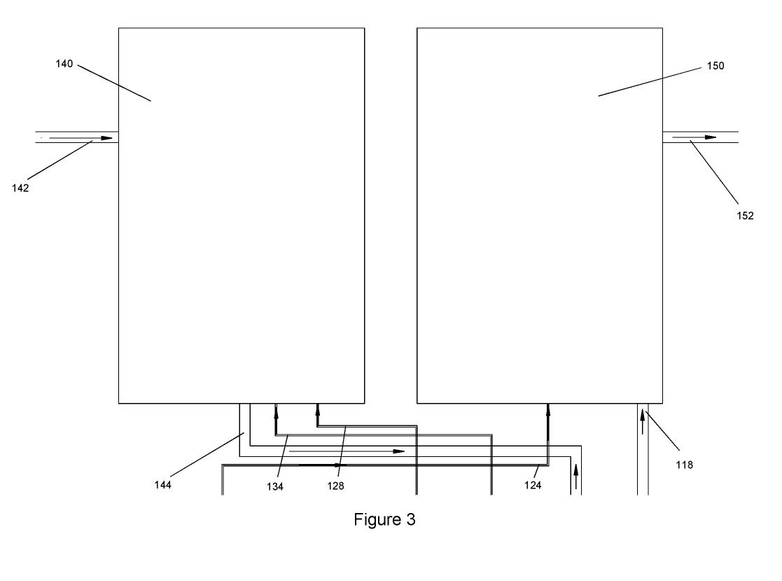

FIG. 2 depicts the main components of a fluid treatment system on a first skid. Fluid, as depicted by arrow 100, enters the first pump 102 from the ozone injection tank on the second skid as depicted in FIG. 3. The first pump 102 then forces the fluid to flow, in the direction indicated by the arrows, through pipe 104 and into multiple electro-coalescing tubes 106. As the fluid flows through the electro-coalescing tubes 106 power is supplied from the power supply 108 through cables 110 to the electrodes (not shown) in each of the electro-coalescing tubes 106. Typically 220 V three phase power is supplied to the power supply 108 by input cables 112. After the fluid has passed through the electro-coalescing tubes 106 the fluid then enters a second pump 114 that in turn forces the fluid out through tubular 118 and into a coagulation tank on the second skid as depicted in FIG. 3. Typically the first skid will also incorporate a polymer injection pump 120 and the polymer tank 122. The polymer injection pump 120 will then supply the coagulating polymer from tank 122 to the coagulation tank on the second skid, as depicted in FIG. 3, via pipe 124. Typically the first skid will also incorporate the sodium hydroxide pump 126 and the sodium hydroxide tank 130. The sodium hydroxide pump 126 supplies the chemical to adjust the pH in the ozone injection tank on the second skid, as depicted in FIG. 3, via pipe 128. Also, the first skid usually includes an ozone generator 132 that supplies of zone to the ozone injection tank on the second skid, as depicted in FIG. 3, via pipe 134.

FIG. 3 depicts the ozone injection tank 140 and the coagulation tank 150 on a second skid. Typically untreated fluid flows into the ozone injection tank 140 through pipe 142. Ozone is then injected into the fluid in the ozone injection tank through pipe 134 that is connected to ozone generator 132 on the first skid as depicted in FIG. 2. At the same time a pH modifier, such as sodium hydroxide, is injected into the fluid in the ozone injection tank, as needed, through pipe 128 that is connected to the sodium hydroxide pump 126 on the first skid as depicted in FIG. 2. Treated fluid is then removed from the ozone injection tank 140 through pipe 144 that is connected to the first pump 102 on the first skid as depicted in FIG. 2.

The fluid is forced into the coagulation tank 150 by the second pump 114 on the first skid, depicted in FIG. 2, via pipe 118. Typically while the fluid is in the coagulation tank 150 an inorganic polymer is injected into the fluid in the coagulation tank through pipe 124 that is connected to the polymer pump 120 on the first skid as depicted in FIG. 2. The fluid typically resides in the coagulation tank 150 long enough for particulant matter to settle to the bottom. The now clean, treated water is removed from the coagulation tank 150 through pipe 152.

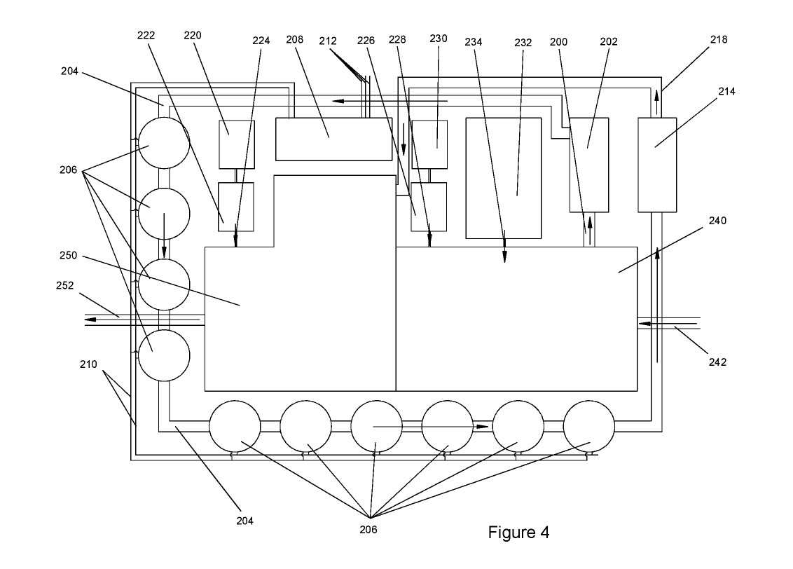

FIG. 4 depicts the main components of a fluid treatment system on a single skid. Fluid, as depicted by arrow 200, enters the first pump 202 from the ozone injection tank 240. The first pump 202 then forces the fluid to flow, in the direction indicated by the arrows, through pipe 204 and into multiple electro-coalescing tubes 206. As the fluid flows through the electro-coalescing tubes 206 power is supplied from the power supply 208 through cables 210 to the electrodes (not shown) in each of the electro-coalescing tubes 206. Typically 220 V three phase power is supplied to the power supply 208 by input cables 212. After the fluid has passed through the electro-coalescing tubes 206 the fluid then enters a second pump 214 that in turn forces the fluid out through tubular 218 and into a coagulation tank 250. Typically the single skid will also incorporate a polymer injection pump 220 and the polymer tank 222. The polymer injection pump 120 will then supply the coagulating polymer from tank 222 to the coagulation tank 250, via pipe 224. Typically the skid will also incorporate the sodium hydroxide pump 226 and the sodium hydroxide tank 230. The sodium hydroxide pump 226 supplies the chemical to adjust the pH in the ozone injection tank 240 via pipe 228. Also, the skid usually includes an ozone generator 232 that supplies of zone to the ozone injection tank 240 via pipe 234.

Typically untreated fluid flows into the ozone injection tank 240 through pipe 242. Ozone is then injected into the fluid in the ozone injection tank 240 through pipe 234 that is connected to ozone generator 232. At the same time a pH modifier, such as sodium hydroxide, is injected into the fluid in the ozone injection tank 240, as needed, through pipe 228 that is connected to the sodium hydroxide pump. Treated fluid is then removed from the ozone injection tank 240 through pipe 244 that is connected to the first pump 202.

The fluid is forced into the coagulation tank 250 by the second pump 214 via pipe 218. Typically while the fluid is in the coagulation tank 150 an inorganic polymer is injected into the fluid in the coagulation tank 250 through pipe 224. The fluid typically resides in the coagulation tank 250 long enough for particulant matter to settle to the bottom. The now clean, treated water is removed from the coagulation tank 250 through pipe 252.

Each of the arrows in FIG. 2, FIG. 3, and FIG. 4 are used to indicate the direction of fluid flow through a pipe.

The entire operation is conducted on equipment that is typically portable. By mounting the equipment on a skid or trailer the fluid management system may be easily moved from site to site as needed. Additionally should the need arise the fluid management system may easily be scaled up to handle any amount of fluid that needs treatment.

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

While the foregoing is directed to embodiments of the present invention, other and further embodiments of the invention may be devised without departing from the basic scope thereof, and the scope thereof is determined by the claims that follow.

What is claimed is:

1. A method of treating water comprising:
injecting ozone into the water;
adjusting the pH of a water; wherein the pH is raised to between 9.0 and 9.4;
flowing the water between at least two bimetallic electrodes;
further wherein the bimetallic electrodes are iron and aluminum;
supplying an electric current to the bimetallic electrodes;
injecting a polyacrylamide coagulant into the water after the water passes between the bimetallic electrodes; wherein adding the polyacrylamide coagulant directly results in a coagulated hydrocarbon, and
allowing the coagulated hydrocarbon to settle out of the water.

2. The method of claim 1, wherein the electric current is DC.

3. The method of claim 2, wherein the electric current supplied to the bimetallic electrodes is reversed after a period of time.

4. The method of claim 1, wherein the pH of the water is raised.

5. The method of claim 4, wherein the pH of the water is raised by injecting NaOH into the water.

6. A fluid treatment system comprising:
a skid having a first tank, an ozone source, and a pH modifying agent,
wherein a contaminated water is introduced into the first tank along with ozone from the ozone source,
wherein the pH is raised to between 9.0 and 9.4,
wherein a multiplicity of first solid particles are allowed to settle out in the first tank,
the skid having a second tank, a polyacrylamide coagulant source, and an electric power supply, wherein the electric power supply is connected to bimetallic electrodes in the second tank,
further wherein the bimetallic electrodes are iron and aluminum;
wherein the contaminated water from the first tank passes between the bimetallic electrodes in the second tank,
wherein a polyacrylamide coagulant is injected into the water after passing the contaminated water out of the second tank having the bimetallic electrodes, wherein adding the polyacrylamide coagulant directly results in a coagulated hydrocarbon, and allowing the coagulated hydrocarbon to settle out of the water.

7. The fluid treatment system of claim 6, wherein the pH modifying agent is NaOH.

8. The fluid treatment system of claim 6, wherein the electric power supply is DC.

9. A fluid treatment system comprising:
a first skid having a first tank, an ozone source, and a pH modifying agent,
wherein a contaminated water is introduced into the first tank along with ozone from the ozone source,
wherein the pH is raised to between 9.0 and 9.4,
wherein a multiplicity of first solid particles are allowed to settle out in the first tank,
a second skid having a second tank, a polyacrylamide coagulant source, and an electric power supply, wherein the electric power supply is connected to bimetallic electrodes in the second tank,
further wherein the bimetallic electrodes are iron and aluminum;
wherein the contaminated water from the first tank passes between the bimetallic electrodes in the second tank,
wherein a polyacrylamide coagulant is injected into the water after passing the contaminated water out of the second tank having the bimetallic electrodes, wherein adding the polyacrylamide coagulant directly results in a coagulated hydrocarbon, and allowing the coagulated hydrocarbon to settle out of the water.

10. The fluid treatment system of claim 9, wherein the pH modifying agent is NaOH.

11. The fluid treatment system of claim 9, wherein the electric power supply is DC.
